(19) United States
(12) Patent Application Publication
(10) Pub. No.: US 2025/0057722 A1
(43) Pub. Date: Feb. 20, 2025

(54) Massager for backs

(71) Applicant: Xi Lu QIAO, Guangzhou Guangdong (CN)

(72) Inventor: Xi Lu QIAO, Guangzhou Guangdong (CN)

(73) Assignee: Reestar International Limited, Kowloon (HK)

(21) Appl. No.: 18/235,096

(22) Filed: Aug. 17, 2023

(51) Int. Cl. A61H 7/00

(52) U.S. Cl. CPC A61H 7/003; A61H 2201/169; A61H 2205/081

(57) ABSTRACT

A massager useful for massaging a user's back muscle is disclosed. The massager comprises a body having a first end extending along a first axis and a second end extending along a second axis. The first end adapts a massage head. The second end adapts a handle. The handle extends along the second axis and comprises a bend angle such that the user may hold the handle to massage his back muscle with the massage head without an assistance of a masseur.

### FIELD OF THE INVENTION

The invention relates to the field of massage equipment, in particular to a massager for the user's back.

### BACKGROUND OF THE INVENTION

The field of the invention is massaging devices, and the invention relates more specifically to devices useful for massaging the user's back, particularly the rhomboid muscles. The benefit and comfort of a back massager is widely recognized and such massages administered by a masseur masseuse have been known for centuries. Unfortunately, the area of the back is difficult to reach without the assistance of a masseur.

U.S. Patent Application Pub. No. 2021/0361519 disclosed a massage gun clamping device for a hand held device capable to massage the user's back. Unfortunately, a wall is required for mounting the massage gun. It is not possible for outdoor use.

U.S. Patent Application Pub. No. 2022/0104997 and 2022/0117841 disclosed massage gun extension arm and holder capable to massage the user's back. However, the size of the extension arm is large and inconvenience for indoor or outdoor use.

U.S. Patent Application Pub. No. 2022/0183917 and 2023/0055917 disclosed massage gun holder capable to massage the user's back. Unfortunately, a wall or a door is required for holding the massage gun. They are not possible for outdoor use.

There is therefore a need for a massaging device which can be used by the user acting alone and which is capable of massaging the user's back, small in size and convenience for outdoor use.

### BRIEF SUMMARY OF THE INVENTION

The invention is for a massager useful for massaging the user's back. The massager comprises a body having a first end extending along a first axis and a second end extending along a second axis. The first end adapts a massage head. The second end adapts a handle. The handle extends along the second axis and comprises a bend angle such that the user may hold the handle to massage his back muscle with the massage head without an assistance of a masseur.

The body of the massager is configured to deliver impart reciprocal movement to the massage head which is preferably made of rubber.

The handle is approximately 14 inches in length and the bend angle is approximately 15 degrees facilitating the massaging of the user's back muscles including, but not limited to, rhomboid muscle, trapezius muscle, latissimus dorsi muscle and levator scapulae muscle.

### BRIEF DESCRIPTION OF THE SEVERAL VIEWS OF THE DRAWINGS

The accompanying drawings illustrate one or more embodiments of the invention and, together with the written description, serve to explain the principles of the invention, and wherein:

FIG. 1 is a front elevation view of the massager of the present invention; and,

FIG. 2 shows a user using the massager massaging his back.

### DETAILED DESCRIPTION OF THE INVENTION

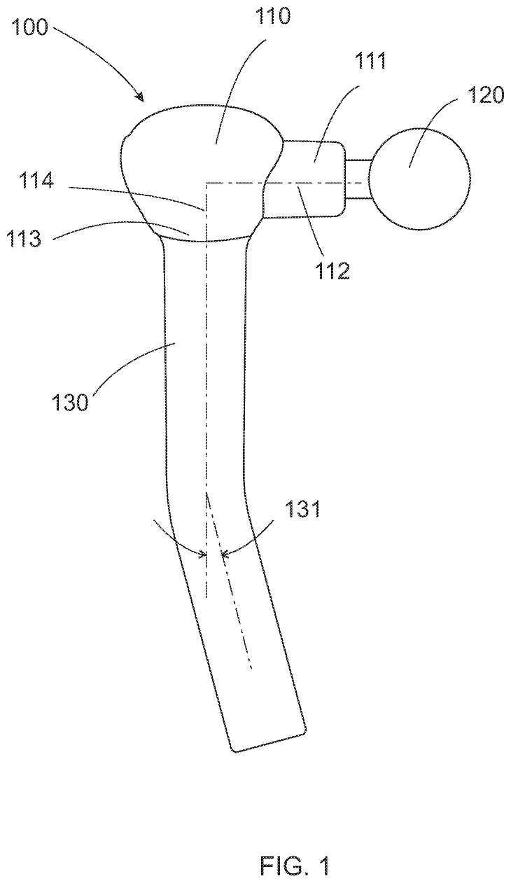

A massager for backs is shown in front elevation view in FIG. 1 and indicated generally by reference character 100. The massager 100 comprises a body 110 having a first end 111 extending along a first axis 112 and a second end 113 extending along a second axis 114. The first end 111 adapts a massage head 120. The second end 113 adapts a handle 130. The handle 130 extends along the second axis 114 and comprises a bend angle 131 such that the user may hold the handle 130 to massage his back muscle with the massage head 120 without an assistance of a masseur.

The body 110 of the massager 100 is configured to deliver impart reciprocal movement to the massage head 120. The reciprocal movement is embodied by configurations including, but not limited to, mechanical linkage, motor and battery power. The massage head 120 is preferably made of rubber.

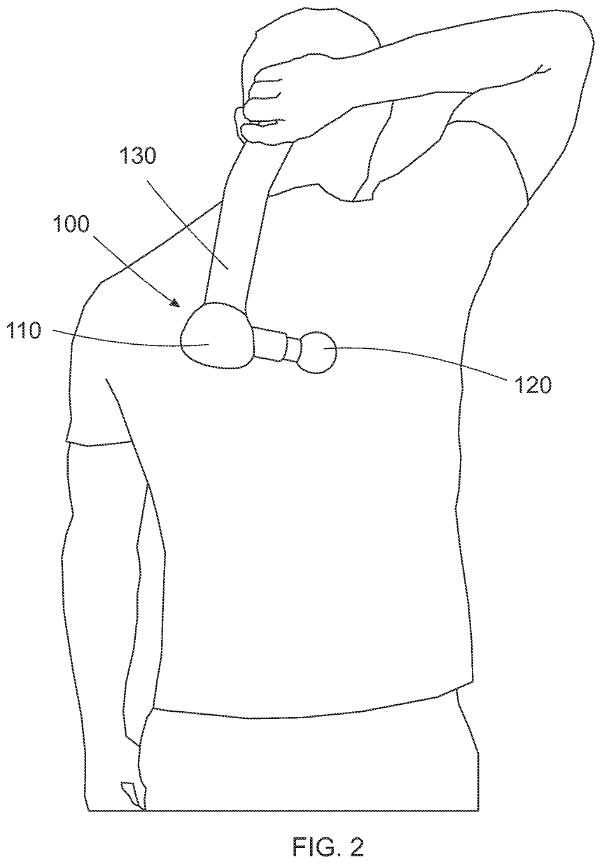

The handle 130 is approximately 14 inches in length and the bend angle 131 is approximately 15 degrees facilitating the massaging of the user's back muscles including, but not limited to, rhomboid muscle, trapezius muscle, latissimus dorsi muscle and levator scapulae muscle, as shown in FIG. 2.

Although the embodiments of the present invention have been shown and described, it will be understood by those skilled in the art that various changes, modifications, substitutions and alterations can be made in these embodiments without departing from the principles and spirit of the present invention. Variations, the scope of the present invention is defined by the claims and their equivalents.

What is claimed is:

1. A massager useful for massaging a user's back muscle, the massager comprising: a body having a first end extending along a first axis and a second end extending along a second axis, the first end adapting a massage head, the second end adapting a handle; wherein the handle extends along the second axis and comprises a bend angle such that the user may hold the handle to massage his back muscle with the massage head without an assistance of a masseur.

2. The massager according to claim 1, characterized in that the handle is approximately 14 inches in length.

3. The massager according to claim 1, characterized in that the bend angle is approximately 15 degrees.

4. The massager according to claim 1, characterized in that the body is configured to be used to impart reciprocal movement to the massage head.

5. The massager according to claim 1, characterized in that the user's back muscle is a rhomboid muscle.

6. The massager according to claim 1, characterized in that the user's back muscle is a trapezius muscle.

7. The massager according to claim 1, characterized in that the user's back muscle is a latissimus dorsi muscle.

8. The massager according to claim 1, characterized in that the user's back is a levator scapulae muscle.

9. The massager according to claim 1, characterized in that the massage head is made of rubber.
